(19) United States
(12) Patent Application Publication
(10) Pub. No.: US 2026/0070252 A1
(43) Pub. Date: Mar. 12, 2026

(54) CUTTING CONTROL METHOD, CUTTING CONTROL SYSTEM, AND INFORMATION PROCESSING DEVICE

(71) Applicant: SEIKO EPSON CORPORATION, TOKYO (JP)

(72) Inventor: Toshiya KONDO, Shiojiri-shi (JP)

(21) Appl. No.: 19/251,797

(22) Filed: Jun. 27, 2025

(30) Foreign Application Priority Data
Jun. 28, 2024 (JP) 2024-104910

(51) Int. Cl. B26D 5/34; B41J 3/01; B41J 11/66

(52) U.S. Cl. CPC B26D 5/34; B41J 3/01; B41J 11/663

(57) ABSTRACT

A cutting control method includes: a first step of generating, based on job image data, first cutting operation data which is data that can be processed when a first cutting machine executes a cutting operation on a cutting target based on the job image data, and second cutting operation data and that can be processed when a second cutting machine executes a cutting operation on the cutting target; a second step of accepting job identification information indicating the cutting target and cutting machine identification information indicating a type of a cutting machine that executes cutting; and a third step of transmitting the first cutting operation data when the cutting machine identification information indicating the first cutting machine is accepted in the second step, and transmitting the second cutting operation data when the cutting machine identification information indicating the second cutting machine is accepted in the second step.

The present application is based on, and claims priority from JP Application Serial Number 2024-104910, filed Jun. 28, 2024, the disclosure of which is hereby incorporated by reference herein in its entirety.

### BACKGROUND

### 1. Technical Field

The present disclosure relates to a cutting control method, a cutting control system, and an information processing device.

### 2. Related Art

According to the related art, it is known that a barcode is printed along with a cutting target image on a medium to be cut by a cutting machine (for example, JP-A-2020-55078). The barcode is printed to acquire cutting operation data for cutting the cutting target image. When cutting the medium, the cutting machine reads the barcode, acquires the cutting operation data represented by the barcode, and performs a cutting operation based on the acquired cutting operation data.

JP-A-2020-55078 is an example of the related art.

According to the related art, a cutting machine to be used in a cutting process is determined in a printing process, then cutting operation data for the cutting machine is generated and saved, and the cutting process is performed by the cutting machine using the saved cutting operation data in the cutting process. However, it may take time between the printing process and the cutting process, and a cutting machine different from a cutting machine determined in the past may be used in the cutting process. In such a case, with the cutting operation data generated in the printing process, the cutting operation cannot be performed (or is difficult to perform) by the cutting machine after the change, and this poses a problem in that the convenience of the user is reduced.

### SUMMARY

According to an aspect of the present disclosure, a cutting control method includes: a first step of generating, based on job image data, first cutting operation data which is data that can be processed when a first cutting machine executes a cutting operation on a cutting target based on the job image data, and second cutting operation data which is data that is different from the first cutting operation data and that can be processed when a second cutting machine executes a cutting operation on the cutting target; a second step of accepting job identification information indicating the cutting target and cutting machine identification information indicating a type of a cutting machine that executes cutting; and a third step of transmitting the first cutting operation data to the first cutting machine when the cutting machine identification information indicating the first cutting machine is accepted in the second step, and transmitting the second cutting operation data to the second cutting machine when the cutting machine identification information indicating the second cutting machine is accepted in the second step.

According to another aspect of the present disclosure, a cutting control system includes: an information processing device; a first cutting machine; and a second cutting machine, and the information processing device includes: a generation unit that generates, based on job image data, first cutting operation data which is data that can be processed when the first cutting machine executes a cutting operation, and second cutting operation data which is data that is different from the first cutting operation data and that can be processed when the second cutting machine executes a cutting operation; an acceptance unit that accepts job identification information indicating a cutting target and cutting machine identification information indicating a type of a cutting machine that executes cutting; and a transmission unit that transmits the first cutting operation data to the first cutting machine when the cutting machine identification information indicating the first cutting machine is accepted, and that transmits the second cutting operation data to the second cutting machine when the cutting machine identification information indicating the second cutting machine is accepted.

According to still another aspect of the present disclosure, an information processing device that communicates with a first cutting machine and a second cutting machine includes: a generation unit that generates, based on job image data, first cutting operation data which is data that can be processed when the first cutting machine executes a cutting operation, and second cutting operation data which is data that is different from the first cutting operation data and that can be processed when the second cutting machine executes a cutting operation; an acceptance unit that accepts job identification information indicating a cutting target and cutting machine identification information indicating a type of a cutting machine that executes cutting; and a transmission unit that transmits the first cutting operation data to the first cutting machine when the cutting machine identification information indicating the first cutting machine is accepted, and that transmits the second cutting operation data to the second cutting machine when the cutting machine identification information indicating the second cutting machine is accepted.

### BRIEF DESCRIPTION OF THE DRAWINGS

FIG. 1 is a block diagram showing an overall configuration.

FIG. 2 is a block diagram showing the configuration of a cutting machine.

FIG. 3 shows an example of a printed object.

FIG. 4 is a block diagram showing the configuration of a printing device.

FIG. 5 is a diagram illustrating a data structure.

FIG. 6 is a flowchart of cutting control processing.

### DESCRIPTION OF EMBODIMENTS

Embodiments of the present disclosure will be described below in the following order.
(1) Overall Configuration
(1-1) Configuration of Cutting Machine
(1-2) Configuration of Cutting Terminal
(1-3) Configuration of Printing Device
(1-4) Configuration of Printing Terminal
(1-5) Configuration of Information Processing Device
(2) Cutting Control Processing
(3) Other Embodiments

### (1) Overall Configuration

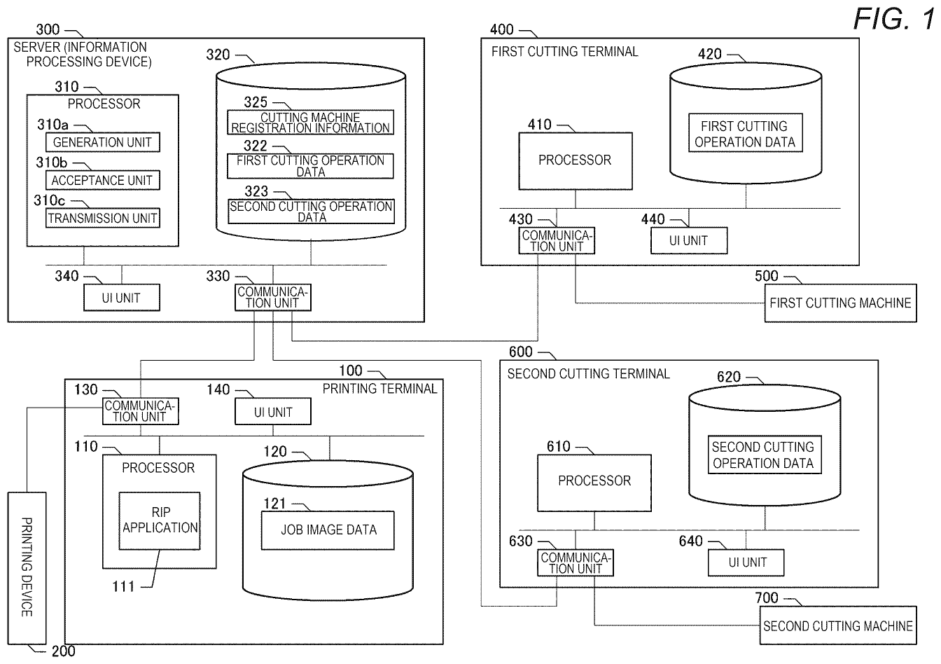

FIG. 1 illustrates an overall configuration of a cutting control system including a server 300 as an information processing device according to an embodiment of the present disclosure. The server 300 executes a cutting control program (not illustrated) and thus cooperates with a printing terminal 100 that controls a printing device 200 that prints a cutting target image or the like, and a cutting terminal (400, 600) that controls a cutting machine (500, 700) that performs a cutting operation.

The printing device 200 in the present embodiment prints a cutting target image on a sheet-shaped (roll paper) medium and thus produces a printed object. The cutting machine (500, 700) cuts the medium (printed object) on which the cutting target image is printed, based on cutting operation data generated according to the shape and the like of the image.

The cutting operation data includes a vector data group (a set of vectors defining a cutting start position and a cutting end position) indicating a cutting line, and an operation command group related to cutting. In the present embodiment, first cutting operation data that can be processed by the first cutting machine 500 and second cutting operation data that can be processed by the second cutting machine 700 are not compatible with each other. Therefore, the first cutting machine 500 cannot perform the cutting operation, based on the second cutting operation data. Also, the second cutting machine 700 cannot perform the cutting operation, based on the first cutting operation data.

In the related art, a cutting machine to be used in a cutting process is determined in a printing process, then cutting operation data for the cutting machine is generated and saved, and the cutting process is performed by the cutting machine using the saved cutting operation data in the cutting process. However, in some cases, it may take time between the printing process and the cutting process, or the company performing the printing process and the company performing the cutting process may be different. In such a case, a cutting machine other than the cutting machine determined in the printing process may be used in the cutting process. However, when cutting operation data that cannot be processed by the cutting machine after change is generated in the printing process, the cutting operation cannot be performed (or is difficult to perform) by the cutting machine after change with this cutting operation data. Therefore, the server 300 in the present embodiment implements a function of generating cutting operation data that is for cutting an image printed by the printing device 200 and that can be processed by a cutting machine that executes the cutting process.

### (1-1) Configuration of Cutting Machine

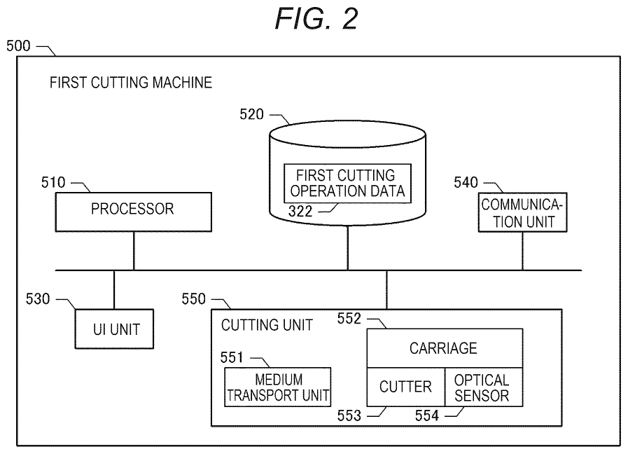

FIG. 2 is a block diagram illustrating the configuration of the first cutting machine 500. The second cutting machine 700 and other cutting machines have a similar configuration and therefore the description of each cutting machine will be omitted, but the configuration and specifications of a cutting unit 550 are different for each cutting machine. The cutting machine is also referred to as a cutting plotter. In the present embodiment, the cutting operation data that can be processed by the first cutting machine 500 and the second cutting machine 700 (first cutting operation data and second cutting operation data) are not compatible with each other.

The first cutting machine 500 includes a processor 510, a nonvolatile memory 520, a UI unit 530, a communication unit 540, and the cutting unit 550. The processor 510 includes a CPU, a ROM, a RAM, and the like, not shown, and executes a cutting control program recorded in the nonvolatile memory 520 and thus controls each part of the first cutting machine 500. Each cutting machine is provided with cutting machine identification information for identifying the type of the cutting machine (manufacturer, model, or the like), and the cutting machine identification information is recorded in, for example, the ROM of the cutting machine.

The processor 510 may be configured with a single chip, may be configured with a plurality of chips, or may be configured as an SoC with various functional blocks. For example, an ASIC may be employed instead of the CPU, or the CPU and the ASIC may cooperatively operate. When each device in the embodiment includes a processor, the processor can be implemented in various forms similar to the processor 510.

The UI unit 530 includes a touch panel display, switches, an LED, a speaker, and the like. The UI unit 530 presents various information about the first cutting machine 500 to the user of the first cutting machine 500 and accepts an operation from the user, under the control of the processor 510. The communication unit 540 includes a communication interface for communicating with another device according to various protocols for wired or wireless communication. In the present embodiment, the first cutting machine 500 can communicate with the first cutting terminal 400 via the communication unit 540. Upon receiving first cutting operation data 322 for executing the cutting operation from the first cutting terminal 400, the processor 510 stores the first cutting operation data 322 in the nonvolatile memory 520.

The cutting unit 550 includes a medium transport unit 551, a carriage 552, a cutter 553, and an optical sensor 554 as a reading device. In the present embodiment, the medium transport unit 551 includes a sensor, an actuator, and a mechanical component for transporting a printed object which is a medium in the form of roll paper and is produced by the printing device 200, based on the first cutting operation data 322.

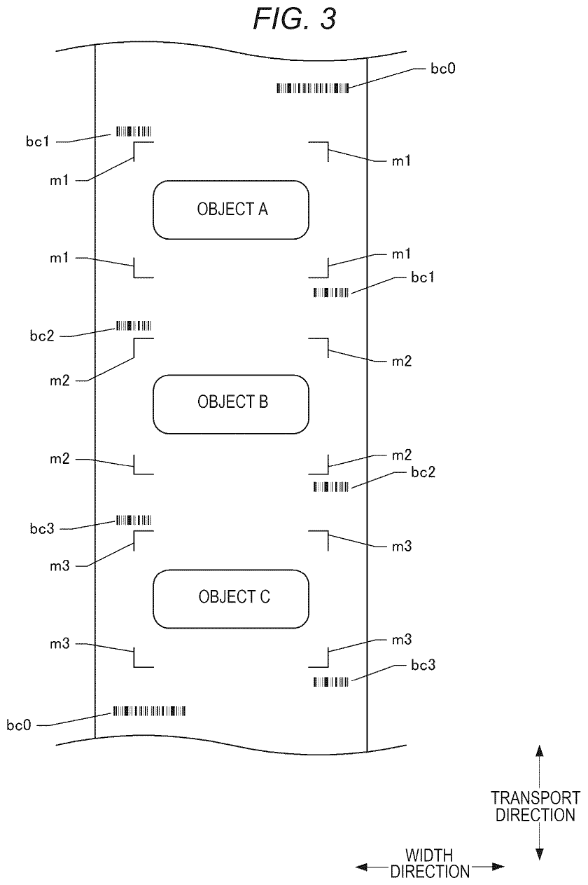

FIG. 3 is a schematic diagram illustrating an example of the printed object, and illustrates a transport direction, which is a direction in which the medium is transported, and a width direction of the medium. The width direction of the medium is a direction orthogonal to the transport direction of the medium. The carriage 552 moves in a direction parallel to the printing surface of the medium set in the first cutting machine 500 by a motor, an actuator, or a mechanical component, not illustrated. In this example, the direction parallel to the printing surface of the medium is, for example, the width direction of the medium. The cutter 553 and the optical sensor 554 are installed on the carriage 552. The cutter 553 held by the carriage 552 is driven in a direction orthogonal to the printing surface of the sheet-shaped medium by an actuator, not illustrated, and the tip of the cutter 553 is brought into contact with or separated from the medium. In a state where the tip of the cutter 553 is in contact with the medium, the carriage 552 holding the cutter 553 moves in the width direction and the medium is transported in the transport direction orthogonal to the direction of movement of the carriage 552, and cutting processing of the image formed on the medium is thus performed. The cutting machine may be a flat-bed-type device in which the medium transport unit is omitted, and in this case, the direction of movement of the carriage 552 is not limited to only the width direction of the medium and includes a longitudinal direction orthogonal to the width direction of the medium. The configuration of the cutting machine is not particularly limited as long as the cutting machine executes cutting by causing the cutter installed on the carriage to run.

The optical sensor 554 moves while being held by the carriage 552. The optical sensor 554 includes a light emitting unit and a light receiving unit, and reads a barcode (bc0 or the like) or a cutting mark (m1 or the like) printed on the medium by causing the light emitting unit to emit light to the medium and causing the light receiving unit to receive reflected light from the medium. The cutting mark is a mark used for the cutting machine to perform position alignment with the medium on which the cutting target image is printed, and the cutting target image is printed in a rectangular area having a reference point of each cutting mark as a vertex. For example, an image (object A) is printed in a rectangular area surrounded by four cutting marks m1 shown in FIG. 3.

The example illustrated in FIG. 3 shows a printed object on the assumption that a plurality of images (objects A, B, and C) are cut all at once by one cutting machine. The barcode bc0 represents one job ID (job identification information) assigned to the objects A, B, and C to be cut all at once. As will be described in detail later, for example, when the first cutting machine 500 reads the job ID, the first cutting operation data 322 including cutting operation data for cutting each of the objects A, B, and C is transmitted from the server 300.

A barcode bc1 includes reference information of the cutting operation data for cutting the object A printed in a rectangular area having the cutting mark m1 located at a predetermined distance from the barcode bc1 as a vertex. The reference information is information for the cutting machine reading the barcode to request individual cutting operation data for cutting the object indicated by the barcode from the cutting terminal coupled to the cutting machine and to acquire the cutting operation data from the cutting terminal. The reference information may be in any form as long as the cutting operation data of the individual object included in the cutting operation data (for example, the first cutting operation data 322) transmitted for the cutting machine reading the barcode can be acquired, and may be assumed to be, for example, identification information of a file of the individual cutting operation data, or the like.

A barcode bc2 includes reference information of the cutting operation data for cutting the object B printed in a rectangular area having a cutting mark m2 located at a predetermined distance from the barcode bc2 as a vertex. A barcode bc3 includes reference information of the cutting operation data for cutting the object C printed in a rectangular area having a cutting mark m3 located at a predetermined distance from the barcode bc3 as a vertex.

The barcodes bc1 are arranged on both sides of the rectangular area indicated by the cutting marks m1 in the transport direction. The barcodes bc2 and bc3, too, are arranged on both sides of the rectangular area indicated by the corresponding cutting marks. The barcode bc0 is arranged at two positions outside the barcodes bc1 and bc3 located at the ends in the transport direction of the objects A, B, and C to be cut all at once.

When a medium is set in the cutting unit 550 and an instruction to read the barcode is given, the processor 510 causes the medium transport unit 551 to transport the medium, moves the carriage 552, and causes the optical sensor 554 to read the barcode bc0. The processor 510 acquires, from the ROM, cutting machine identification information indicating the first cutting machine 500, which is the own cutting machine. The processor 510 transmits the job identification information indicated by the read barcode bc0 and the cutting machine identification information indicating the cutting machine reading the barcode, to the first cutting terminal 400. Upon receiving the job identification information and the cutting machine identification information, the first cutting terminal 400 transmits the job identification information and the cutting machine identification information to the server 300, and causes the server 300 to transmit the first cutting operation data 322, which is the cutting operation data for cutting the object corresponding to the job identification information by the cutting machine indicated by the cutting machine identification information and which is in a format that can be processed by the cutting machine. In the present embodiment, the first cutting operation data 322 includes cutting operation data for cutting the object A, cutting operation data for cutting the object B, and cutting operation data for cutting the object C, the objects A to C being shown in FIG. 3. The first cutting terminal 400 saves the first cutting operation data 322 received from the server 300 in a nonvolatile memory 420.

Subsequently, the processor 510 of the first cutting machine 500 reads the barcode bc1, requests the first cutting terminal 400 for the cutting operation data (cutting operation data related to the object A, of the first cutting operation data 322), based on the reference information indicated by the barcode bc1, and acquires the cutting operation data from the first cutting terminal 400. The processor 510 performs the cutting operation, based on the cutting operation data acquired from the first cutting terminal 400. Specifically, for example, the processor 510 reads the cutting mark m1 and performs position alignment for the cutting operation (for example, using a position on the medium indicated by one of the four cutting marks m1, as a reference for driving the medium transport unit 551 and the carriage 552). The processor 510 also controls the medium transport unit 551, the carriage 552, and the cutter 553, based on the vector data group or the command group represented by the acquired cutting operation data, and thus performs the cutting operation.

Subsequently, the processor 510 of the first cutting machine 500 reads the barcode bc2, requests the first cutting terminal 400 for the cutting operation data corresponding to the reference information indicated by the barcode bc2, acquires the cutting operation data from the first cutting terminal 400, and performs the cutting operation, based on the cutting operation data. After that, the processor 510 similarly performs the cutting operation on the object corresponding to the barcode bc3.

In the present embodiment, each of the first cutting machine 500 and the second cutting machine 700 includes an optical sensor (equivalent to a reading device corresponding to each cutting machine) as a reading device. Therefore, each cutting machine can read the job identification information with the optical sensor provided in the own cutting machine. Each of the first cutting machine 500 and the second cutting machine 700 stores the own cutting machine identification information. Therefore, each cutting machine can specify the cutting machine identification information stored therein as the cutting machine identification information indicating the cutting machine corresponding to the optical sensor reading the job identification information.

### (1-2) Configuration of Cutting Terminal

As shown in FIG. 1, in the present embodiment, one cutting terminal is coupled to each cutting machine. In FIG. 1, the cutting terminal corresponding to the first cutting machine 500 is referred to as the first cutting terminal 400, and the cutting machine corresponding to the second cutting machine 700 is referred to as the second cutting terminal 600. The cutting terminal is a computer such as a PC or a tablet.

In this example, the first cutting terminal 400 will be described as a configuration of the cutting terminal. Since the second cutting terminal 600 has a configuration similar to that of the first cutting terminal 400, the description thereof will be omitted. The first cutting terminal 400 includes a processor 410, the nonvolatile memory 420, a communication unit 430, and a UI unit 440.

The communication unit 430 includes a communication interface that communicates with another device according to various protocols for wired or wireless communication. In the present embodiment, the processor 410 can communicate with the printing terminal 100 and the first cutting machine 500 via the communication unit 430. The communication unit 430 may include an interface for communicating with various removable memories attached to the printing device 200. The UI unit 440 includes a display and a switch, and the processor 410 displays various information on the display and accepts an operation performed on the switch.

When the user selects the use of the first cutting machine 500 in the cutting process, which is a post-process of the printing process, the user sets the printed object in the first cutting machine 500 and gives an instruction to read the barcode printed on the printed object. When the processor 410 of the first cutting terminal 400 acquires the job identification information indicated by the barcode bc0 read by the first cutting machine 500 and the cutting machine identification information indicating the first cutting machine 500 from the first cutting machine 500, the processor 410 transmits these pieces of information to the server 300 and requests the server 300 to transmit the first cutting operation data 322, which is the cutting operation data corresponding to these pieces of information. The server 300 sends back the first cutting operation data 322 including the cutting operation data for the first cutting machine 500 to cut the objects A, B, and C indicated by the barcode bc0, to the first cutting terminal 400, which is the requester. The first cutting terminal 400 acquires the received first cutting operation data 322 and stores the first cutting operation data 322 in the nonvolatile memory 420. The processor 410 transmits the cutting operation data included in the first cutting operation data 322 to the first cutting machine 500 in response to the acquisition request for the cutting operation data of each object from the first cutting machine 500. As described above, the first cutting machine 500 performs the cutting operation, based on the cutting operation data.

### (1-3) Configuration of Printing Device

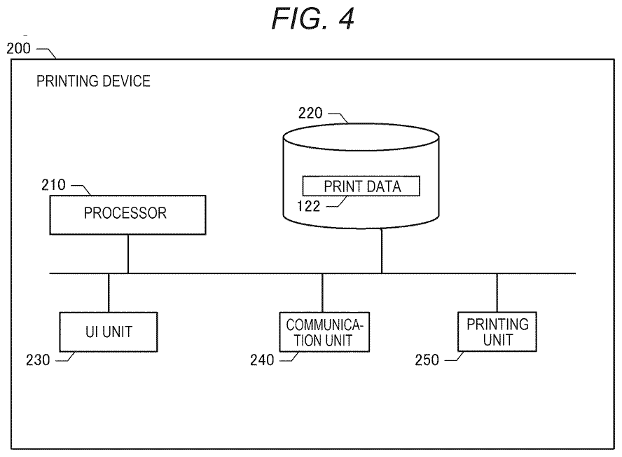

FIG. 4 is a block diagram showing the configuration of the printing device 200. The printing device 200 includes a processor 210, a nonvolatile memory 220, a UI unit 230, a communication unit 240, and a printing unit 250. The processor 210 executes a control program, not shown, which is recorded in the nonvolatile memory 220, and thus can control each unit of the printing device 200.

The nonvolatile memory 220 stores print data 122 transmitted from the printing terminal 100, and the processor 210 controls the printing unit 250, based on the print data 122, and thus executes printing.

The UI unit 230 includes a touch panel display, keys, an LED, a speaker, and the like. The processor 210 guides the user to various information via an output unit such as a touch panel display, an LED, or a speaker, and inputs an instruction of the user via an input unit such as a touch panel display or a key.

The communication unit 240 includes a communication interface for communicating with another device according to various protocols for wired or wireless communication. In the present embodiment, the processor 210 can communicate with the printing terminal 100 via the communication unit 240. The communication unit 240 may include an interface for communicating with various removable memories attached to the printing device 200.

In the present embodiment, the printing unit 250 executes printing on a medium in the form of roll paper. The printing unit 250 includes a medium transport unit, not illustrated, and a carriage with a print head installed thereon. The print head includes nozzle rows corresponding to, for example, cyan, magenta, yellow, and black inks, and the inks are ejected from the nozzles provided in the nozzle rows. The carriage moves forward and backward along a specific direction (main scanning direction). The medium transport unit transports a print target medium. The medium transport unit transports the medium in a direction perpendicular to the main scanning direction. As the ejection of the inks from the nozzles in the process of the forward and backward movement of the print head and the transport of the medium by the medium transport unit are repeated, printing on the medium is performed.

The user sets the medium in the printing device 200 and operates the printing terminal 100 to instruct the printing device 200 to execute printing. Also, the user removes the medium (printed object) after the execution of printing from the printing device 200, moves the medium, sets the medium in the cutting machine used in the cutting process, which is a post-process of the printing process, and causes the cutting machine to execute the cutting operation on the medium.

### (1-4) Configuration of Printing Terminal

The configuration of the printing terminal 100 will be described with reference to FIG. 1. The printing terminal 100 is a computer such as a PC or a tablet. The printing terminal 100 includes a processor 110, a nonvolatile memory 120, a communication unit 130, and a UI unit 140. The nonvolatile memory 120 stores a RIP application 111, various other programs, job image data 121, and the like.

The UI unit 140 includes a display, a touch panel, a speaker, a microphone, and the like. In the present embodiment, the processor 110 inputs various instructions from the user via the UI unit 140 and outputs various information to the user.

The communication unit 130 includes an interface circuit for communicating with another device. The processor 110 can communicate with the printing device 200 and the server 300 via the communication unit 130. Peripheral devices such as a keyboard, a mouse, and a display may be coupled to the printing terminal 100 via the communication unit 130, and the processor 110 may be configured to input various information from these peripheral devices or output various information thereto.

The processor 110 of the printing terminal 100 executes the RIP application 111. RIP is an abbreviation of “raster image processor”, but the RIP application 111 is not limited to the generation of a raster image for the execution of printing by the printing device 200 and executes various kinds of processing, described later, by being executed by the processor 110. Hereinafter, the processing implemented by the function of the RIP application 111 is referred to as RIP processing. The user registers the cutting machine identification information of the cutting machine that may be used in the cutting process, in the server 300 in advance, using the RIP application 111. In the server 300, the registered cutting machine identification information is recorded as cutting machine registration information 325 in a nonvolatile memory 320. In the present embodiment, the description will be continued on the assumption that the cutting machine identification information (cutting machine ID: CUT001) of the first cutting machine 500 and the cutting machine identification information (cutting machine ID: CUT002) of the second cutting machine 700 are registered as the cutting machine registration information 325.

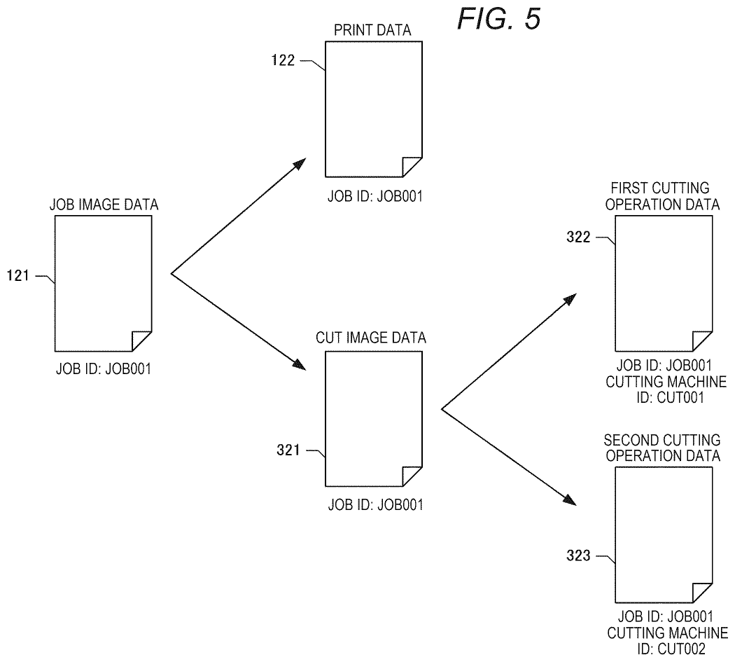

The user also designates job image data of a print target, using the RIP application 111. The processor 110 accepts the designated job image data. FIG. 5 is a diagram illustrating each data structure in the present embodiment. The job image data 121 includes a print target object to be printed by the printing device 200 and an object indicating a cutting line. In the present embodiment, the object indicating the cutting line is an object of a line shown in a spot color with a predetermined name (for example, Cut Contour). Note that the object indicating the cutting line may be any object prescribed in advance to indicate the cutting line, and may be expressed in any form in another embodiment.

The user can give an instruction for the RIP process, designating various print conditions (for example, the size of the medium, the type of the medium, the type of the printing device, and the resolution) and cutting conditions (the assignment of a cutting mark or a barcode, or the like). As for the cutting conditions, when the assignment of a cutting mark and a barcode to each object is designated, for example, as shown in FIG. 3, the processor 110 arranges a cutting mark (m1 or the like) at positions surrounding the object for each object, and generates and arranges a barcode (bc1 or the like) representing reference information of the object in the area surrounded by the cutting marks, at a position separated from the cutting marks by a predetermined distance.

When a plurality of objects printed on a printed object are to be cut all at once by the same cutting machine, as shown in FIG. 3, the processor 110 requests the server 300 to issue a job ID (job identification information) for the plurality of objects. In response to the request from the printing terminal 100, the server 300 issues a job ID, and notifies the printing terminal 100 of the job ID. The processor 110 generates the barcode bc0 indicating the job ID and arranges the barcode bc0 at a position where the barcode bc0 can be read before the barcode (bc1 or the like) of each object in the transport direction. In this example, the barcodes (bc0, bc1, and the like) are generated in a form readable by the reading devices corresponding to the first cutting machine 500 and the second cutting machine 700. That is, preferably, the barcode may be generated according to a generally used standard that can be commonly read by the optical sensors of the first cutting machine 500 and the second cutting machine 700.

When the user designates the various print conditions and cutting conditions and gives an instruction for the RIP processing, the processor 110 rasterizes the print target object, based on the print conditions, and thus generates the print data 122 (see FIG. 5). The print data 122 may be data generated through processing such as color conversion processing, halftone processing, and the like after rasterization processing. The distribution of each processing for executing printing between the printing terminal 100 and the printing device 200 may be implemented in various forms.

In response to the instruction for the RIP processing, the processor 110 generates cut image data 321 (see FIG. 5), based on the object indicating the cutting line included in the job image data 121. The cut image data 321 is data indicating the shape of the cutting line extracted from the job image data 121 and is a set of data indicating the shape of the cutting line. When the job image data 121 includes an object having a predetermined name indicating a cutting line, cut image data can be generated, based on this object. The object indicating the cutting line is not a print target. Also, since the cut image data indicating the cutting line in the present embodiment does not include the information of the print target image (does not include the image of the cutting mark or the barcode, either), the data size can be reduced as compared with when the cut image data includes the information of the print target image.

When the printed object as illustrated in FIG. 3 is to be produced, the cut image data 321 includes data indicating the shape of the cutting line of the object A, data indicating the shape of the cutting line of the object B, and data indicating the shape of the cutting line of the object C.

As described above, the processor 110 generates the print data 122 and the cut image data 321, based on the job image data 121, as shown in FIG. 5. In the present embodiment, the description will be continued on the assumption that a common job ID (JOB001, job identification information) is assigned to the job image data 121, the print data 122, and the cut image data 321, as shown in FIG. 5. As long as the correspondence relationship between the data shown in FIG. 5 can be referred to, a common job ID may not necessarily be assigned to the data.

Upon accepting a print instruction from the user, the processor 110 transmits the print data 122 to the printing device 200 and causes the printing device 200 to execute a printing operation based on the print data 122. As a result, the printed object as shown in FIG. 3 is printed. That is, in the present embodiment, the printing device 200 prints the barcode bc0, which is an image indicating the job ID (JOB001, job identification information), on a medium. Through such steps, a printed object on which printing based on the print data 122 generated based on the job image data 121 is performed is produced. Therefore, as described above, the cutting machine can cut the cutting target printed on the printed object.

The processor 110 transmits the cut image data 321 generated based on the job image data 121 to the server 300 in association with the job ID. Upon receiving the job ID and the cut image data 321 transmitted from the printing terminal 100, the server 300 generates cut operation data corresponding to each type of cutting machine registered as the cutting machine registration information 325, based on the cut image data 321, and saves the cut operation data in association with the job ID (job identification information). Since the image indicating the job ID (job identification information) is printed on the printed object on which the cutting target object is printed, the cutting machine can specify the job ID corresponding to the cutting target object, based on the image. Since the image indicating the job ID (job identification information) is printed in the form of a barcode, the job ID can be automatically acquired by the optical sensor of the cutting machine and the barcode recognition processing. Therefore, with this configuration, the job ID indicating the cutting target object printed on the printed object can be easily specified.

### (1-5) Configuration of Information Processing Device

The configuration of the server 300 as an information processing device according to the present embodiment will now be described with reference to FIG. 1. The server 300 includes a processor 310, a nonvolatile memory 320, a communication unit 330, and a UI unit 340. The nonvolatile memory 320 stores a cutting control program (not shown), various other programs, and the like.

Also, the non-volatile memory 320 stores the cutting machine identification information registered by the user via the printing terminal 100, as the cutting machine registration information 325. A generation program (not shown) for generating cutting operation data for each type of cutting machine is also stored in the nonvolatile memory 320. In the application process of the printing process and the cutting process, the nonvolatile memory 320 stores the first cutting operation data 322 and second cutting operation data 323 generated for each registered type of cutting machine, based on the cut image data 321 transmitted from the printing terminal 100.

The UI unit 340 includes a display, a touch panel, a switch, a keyboard, and the like. The communication unit 330 includes an interface circuit for communicating with another device. The processor 310 can communicate with the printing terminal 100, the first cutting terminal 400, and the second cutting terminal 600 via the communication unit 330. Peripheral devices such as a keyboard, a mouse, and a display may be coupled to the server 300 via the communication unit 330, and the processor 310 may be configured to input various information from these peripheral devices or output various information thereto.

As the processor 310 executes a cutting control program, not illustrated, and thus acquires information indicating the type of the cutting machine registered by the user prior to the printing process and the cutting process, the processor 310 saves the information as the cutting machine registration information 325 in the nonvolatile memory 320.

The processor 310 executes the cutting control program, not illustrated, and thus functions as a generation unit 310a, an acceptance unit 310b, and a transmission unit 310c. With the function of the generation unit 310a, the processor 310 generates, based on the job image data, the first cutting operation data 322, which is data that can be processed when the first cutting machine 500 executes the cutting operation on the cutting target based on the job image data, and the second cutting operation data 323, which is data that can be processed when the second cutting machine 700 executes the cutting operation on the cutting target (this processing is an example of a first step). That is, upon receiving the cut image data 321 from the printing terminal 100, the processor 310 generates the cut operation data corresponding to each type of the cutting machine registered as the cutting machine registration information 325, from the cut image data 321. Specifically, when the first cutting machine 500 and the second cutting machine 700 are registered as the cutting machine registration information 325, the processor 310 generates the first cutting operation data 322, which is data that can be processed by the first cutting machine 500, and the second cutting operation data 323, which is data that can be processed by the second cutting machine 700, from the cut image data 321, as shown in FIG. 5. In the present embodiment, since the first cutting machine 500 and the second cutting machine 700 have different cutting operation specifications, the first cutting operation data 322 and the second cutting operation data 323, which are different from each other, are generated from the same cut image data 321.

Specifically, in the case of the printed object as shown in FIG. 3, the first cutting operation data 322 including the cutting operation data that is the cutting operation data of each of the objects A, B, and C and that can be processed by the first cutting machine 500, and the second cutting operation data 323 including the cutting operation data that is the cutting operation data of each of the objects A, B, and C and that can be processed by the second cutting machine 700, are generated. In the first cutting operation data 322, the same job ID (JOB001) as in the cut image data 321, from which the first cutting operation data 322 is generated, and the cutting machine identification information (cutting machine ID: CUT001) of the first cutting machine 500, are saved in association with each other. In the second cutting operation data 323, this job ID (JOB001) and the cutting machine identification information (cutting machine ID: CUT002) of the second cutting machine 700 are saved in association with each other.

The cutting operation data generated in the first step differs, depending on the cutting machine registration information 325. That is, the cutting operation data generated in the first step differs, depending on the type of the cutting machine registered as the cutting machine registration information 325. For example, if a third cutting machine, a fourth cutting machine, and a fifth cutting machine are registered as the cutting machine registration information 325, the processor 310 generates third cutting operation data that can be processed by the third cutting machine, fourth cutting operation data that can be processed by the fourth cutting machine, and fifth cutting operation data that can be processed by the fifth cutting machine, based on the cut image data 321. Therefore, the processor 310 of the server 300 can generate the cutting operation data corresponding to the type of the cutting machine registered as the cutting machine registration information 325.

As shown in FIG. 5, when the first cutting operation data 322 and the second cutting operation data 323 are generated in the first step, a common job ID (JOB001, job identification information) is assigned to both the first cutting operation data 322 and the second cutting operation data 323, and the job ID is saved in the nonvolatile memory 320 in association with each of the first cutting operation data 322 and the second cutting operation data 323. Therefore, whichever one of the first cutting machine 500 and the second cutting machine 700 is used to cut the cutting target in the cutting process, the cutting operation data corresponding to the cutting target and also corresponding to the cutting machine can be specified, based on the job identification information, as described later.

With the function of the acceptance unit 310b, the processor 310 accepts the job identification information indicating the cutting target and the cutting machine identification information indicating the type of the cutting machine that executes the cutting (this processing is an example of a second step). That is, when the user gives an instruction to read the barcode bc0 of the printed object by the cutting machine used in the cutting process, the server 300 receives the job identification information indicated by the barcode bc0 and the cutting machine identification information indicating the type of the cutting machine from the cutting machine reading the barcode (described as the first cutting machine 500) via the cutting terminal. As described above, the job ID (job identification information) is printed on the medium. The job identification information is read from the medium by a reading device corresponding to each cutting machine (in the present embodiment, the optical sensor provided in the cutting machine). The cutting machine identification information is information indicating the cutting machine corresponding to the reading device reading the job identification information of the medium (in the present embodiment, the cutting machine provided with the optical sensor reading the job identification information). Since a configuration in which the reading device corresponding to the cutting machine reads the job identification information is employed, the server 300 can specify the cutting machine corresponding to the reading device reading the job identification information of the cutting target medium and can specify the cutting machine used in the cutting process.

With the function of the transmission unit 310c, the processor 310 transmits the first cutting operation data to the first cutting machine when the cutting machine identification information indicating the first cutting machine is accepted in the second step, and transmits the second cutting operation data to the second cutting machine when the cutting machine identification information indicating the second cutting machine is accepted in the second step (this processing is an example of a third step). That is, when accepting the job ID (job identification information) and the cutting machine identification information from the first cutting machine 500 via the first cutting terminal 400, the processor 310 transmits the first cutting operation data 322 generated in the first step to the first cutting machine 500 via the first cutting terminal 400. The first cutting machine 500 then performs the cutting operation as described above, based on the first cutting operation data 322. When the job ID (job identification information) and the cutting machine identification information are accepted from the second cutting machine 700 via the second cutting terminal 600, the processor 310 transmits the second cutting operation data 323 generated in the second step to the second cutting machine 700 via the second cutting terminal 600.

As described above, according to the present embodiment, the type of the cutting machine that may be used in the cutting process is specified, based on the cutting machine registration information registered in advance, and the cutting operation data is generated from the cut image data for each type and saved. Then, when the cutting machine to be used is determined, the cutting operation data corresponding to the type of the cutting machine to be used is selected from the cutting operation data generated in advance and transmitted to the cutting machine. Therefore, the cutting machine can be made to execute cutting process, based on the cutting operation data that can be processed by the cutting machine used in the cutting process on the medium. As a result, the convenience of the user can be improved.

### (2) Cutting Control Processing

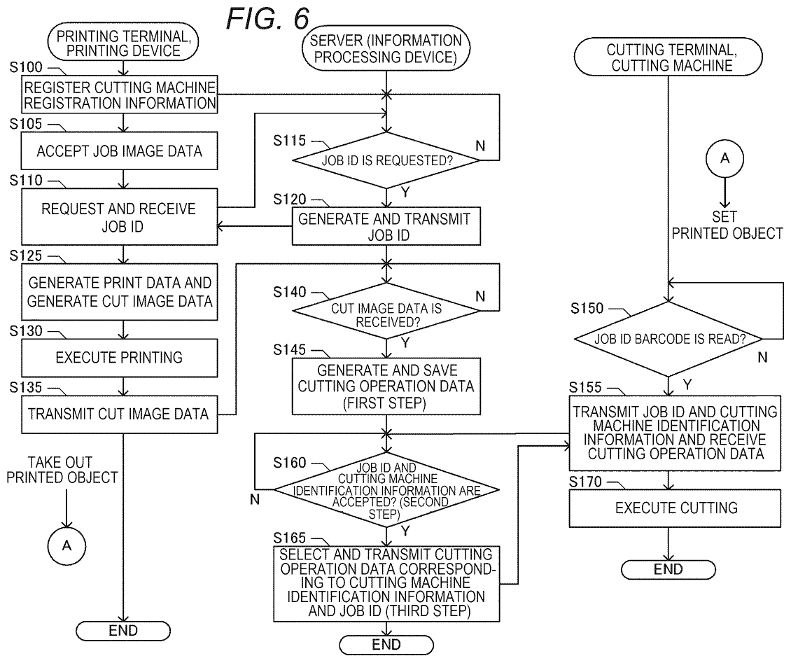

FIG. 6 is a flowchart illustrating cutting control processing executed by the printing terminal 100, the printing device 200, the server 300, the cutting terminal, and the cutting machine. The user registers the cutting machine registration information in advance in the server 300 via the printing terminal 100 (step S100). That is, the user registers the cutting machine identification information indicating the type of the cutting machine that may be used in the cutting process, in the server 300. In the present embodiment, the cutting machine identification information of the first cutting machine 500 and the cutting machine identification information of the second cutting machine 700 are registered. The processor 310 of the server 300 saves the cutting machine identification information of the cutting machine transmitted from the printing terminal 100, as the cutting machine registration information 325 in the nonvolatile memory 320.

When the user operates the UI unit 140 of the printing terminal 100 to designate a print target image, the processor 110 of the printing terminal 100 accepts the image as job image data (step S105). In this example, the description will be continued on the assumption that the three objects A, B, and C are accepted, for example, as shown in FIG. 3. Subsequently, the processor 110 requests the server 300 to issue a job ID (step S110). That is, the issuance of a job ID corresponding to the three objects A, B, and C shown in FIG. 3 is requested.

At the server 300, the processor 310 determines whether the issuance request for the job ID is received (step S115), generates the job ID when the issuance request for the job ID is received, and sends back the generated job ID to the requester (step S120). In step S110, the processor 110 of the printing terminal 100 receives the job ID sent back from the server 300.

Subsequently, upon accepting the designation of a print condition and a cutting condition (including the arrangement of a cutting mark and a barcode) and a RIP instruction from the user, the processor 110 of the printing terminal 100 generates print data and cut image data (step S125). That is, the processor 110 arranges and sets the cutting marks (m1, m2, and m3 shown in FIG. 3) surrounding each object of the job image data 121 accepted in step S105, as a print target on the medium. For each object, the processor 110 arranges and sets the barcodes (bc1, bc2, and bc3) indicating the reference information of the object, as a print target on the medium, at a position at a predetermined distance from the cutting mark. Also, the processor 110 arranges and sets the barcode bc0 indicating the job ID acquired in step S110 as a print target at positions sandwiching all the objects indicated by the job ID and the barcodes and the cutting marks thereof. Then, the processor 110 rasterizes the image including the objects, the barcodes and the cutting marks that are arranged and set as the print target, and thus generates the print data 122. The processor 110 generates the cut image data 321 including the cut image data of each object, based on the object indicating the cutting line included in the job image data 121.

Subsequently, upon accepting a print instruction from the user, the processor 110 of the printing terminal 100 executes printing (step S130). That is, the processor 110 transmits the print data 122 generated in step S120 to the printing device 200 and causes the printing device 200 to execute printing. As a result, the printed object as shown in FIG. 3 is printed.

Subsequently, the processor 110 of the printing terminal 100 transmits the cut image data to the server 300 (step S135). That is, the processor 110 transmits the cut image data 321 generated based on the job image data 121 to the server 300 in association with the job ID. When the server 300 receives the cut image data and the job ID transmitted in step S135 (step S140), the processor 310 of the server 300 generates and saves cut operation data, based on the cut image data 321 (step S145, first step). That is, the processor 310 refers to the cutting machine registration information 325 registered in step S100 and specifies the type of the registered cutting machine. The processor 310 generates cutting operation data based on the cut image data 321 for each specified type of cutting machine. In the present embodiment, the processor 310 generates the first cutting operation data 322 and the second cutting operation data 323, and saves these data in the nonvolatile memory 320 in association with the job ID.

When the printing by the printing device 200 is completed, the user takes out the printed object from the printing device 200. Also, the user sets the printed object in a cutting machine that performs the cutting process (the description will be continued on the assumption that the cutting machine is the first cutting machine 500). After setting the printed object in the first cutting machine 500, the user instructs the first cutting machine 500 to read the barcode bc0 of the printed object. The processor 510 of the first cutting machine 500 causes the optical sensor 554 to read the barcode bc0 (step S150) and then transmits the job ID indicated by the read barcode bc0 and the cutting machine identification information indicating the type of the cutting machine to the server 300 (step S155).

The processor 310 of the server 300 determines whether the job ID and the cutting machine identification information are received (step S160, second step), and when the job ID and the cutting machine identification information are received, the processor 310 selects the cutting operation data associated with the cutting machine of the transmitter and the job ID and transmits the cutting operation data to the transmitter (step S165, third step). That is, in the present embodiment, the first cutting operation data 322 corresponding to the read job ID and the first cutting machine 500 reading the job ID is transmitted to the first cutting terminal 400. In step S155, the first cutting terminal 400 of the transmitter receives the first cutting operation data 322.

The processor 510 of the first cutting machine 500 executes cutting (step S170). That is, the processor 510 of the first cutting machine 500 reads the barcode bc1 following the barcode bc0, acquires the cutting operation data from the first cutting terminal 400, based on the reference information indicated by the barcode bc1, causes the cutting unit 550 to operate, based on the cutting operation data, and thus executes the cutting. The first cutting machine 500 performs similar processing and executes cutting with respect to the barcodes from the barcode bc2 onward.

### (3) Other Embodiments

The foregoing embodiment is an example for carrying out the present disclosure, and various other embodiments can be employed. For example, the printing terminal may be integrated with the printing device. The device that accepts the job image data and the device that generates the print data and the cut image data, based on the job image data, may be configured separately. The cutting terminal may be integrated with the cutting machine. The information processing device, the printing terminal, and the cutting terminal may be integrated together.

The image indicating the job identification information printed on the medium by the printing device is not limited to the barcode. For example, the job identification information may be printed in the form of a character string including numbers, alphabetic letters, symbols, or the like, or may be printed in the form of a two-dimensional code.

The job identification information printed in the form of a character string may be read by a reading device and determined by OCR processing or the like, or may be configured such that the user himself or herself visually recognizes a number or the like printed on the medium and manually inputs the number or the like to a cutting machine, a cutting terminal, or the like. The cutting machine identification information may also be manually input by the user. The job identification information may be a file name or the like indicating the job image data.

The reading device that reads the job identification information may be an optical sensor provided in the cutting machine main body, or may be a barcode reader, a handheld scanner, or a camera coupled to the cutting machine or the cutting terminal. The job identification information and the cutting machine identification information may be acquired by reading the job identification information printed on the medium with a handheld scanner or the like and reading an image indicating the cutting machine identification information attached to the casing of the cutting machine, for example.

The barcodes (for example, the barcodes bc1, bc2, and bc3 illustrated in FIG. 3) assigned to the individual cutting target objects printed on the medium may function as the job identification information. In this case, the barcode (for example, bc0 illustrated in FIG. 3) indicating the job ID of the entire cutting job in which the individual objects are collectively handled may be omitted.

The registration of the cutting machine registration information 325 is not limited to being performed using the RIP application 111 from the printing terminal 100. Any form may be used as long as the cutting machine registration information 325 can be registered in the server 300.

It should be noted that, in the above-described embodiment, the object to which the predetermined name is given in the job image data is specified as the data indicating the cutting line, and the cut image data is generated based on this object, but the job image data itself may be treated as the cut image data. In this case, the cutting operation data is generated from the job image data itself. For example, the contour line of the outer periphery of the print target object indicated by the job image data may be extracted, and the cutting operation data may be generated using the contour line as the cutting line. In this case, even when the job image data does not include the data directly indicating the cutting line, the cut image data indicating the cutting line can be generated from the job image data itself.

The present disclosure can also be applied as a program executed by a computer or as a method. For example, the above contents can also be applied as the disclosure of a cutting control system including an information processing device, a first cutting machine, and a second cutting machine. In the cutting control system, the information processing device includes: a generation unit that generates, based on job image data, first cutting operation data which is data that can be processed when the first cutting machine executes a cutting operation, and second cutting operation data which is data that is different from the first cutting operation data and that can be processed when the second cutting machine executes a cutting operation; an acceptance unit that accepts job identification information indicating a cutting target and cutting machine identification information indicating a type of a cutting machine that executes cutting; and a transmission unit that transmits the first cutting operation data to the first cutting machine when the cutting machine identification information indicating the first cutting machine is accepted, and that transmits the second cutting operation data to the second cutting machine when the cutting machine identification information indicating the second cutting machine is accepted.

The above contents can also be applied as the disclosure of an information processing device that communicates with a first cutting machine and a second cutting machine. The information processing device includes: a generation unit that generates, based on job image data, first cutting operation data which is data that can be processed when the first cutting machine executes a cutting operation, and second cutting operation data which is data that is different from the first cutting operation data and that can be processed when the second cutting machine executes a cutting operation; an acceptance unit that accepts job identification information indicating a cutting target and cutting machine identification information indicating a type of a cutting machine that executes cutting; and a transmission unit that transmits the first cutting operation data to the first cutting machine when the cutting machine identification information indicating the first cutting machine is accepted, and that transmits the second cutting operation data to the second cutting machine when the cutting machine identification information indicating the second cutting machine is accepted.

Also, the system, the program, and the method as described above may be implemented as a stand-alone device in some cases, or may be implemented using components provided in a plurality of devices in some cases, and include various aspects. Also, the present disclosure may be changed as appropriate, such as a part being software and a part being hardware. Moreover, the present disclosure can be applied as a recording medium of a program that controls the system. Obviously, the recording medium storing the program may be a magnetic recording medium or may be a semiconductor memory, and any recording medium to be developed in the future can be similarly employed.

What is claimed is:

1. A cutting control method comprising:
a first step of generating, based on job image data, first cutting operation data which is data that can be processed when a first cutting machine executes a cutting operation on a cutting target based on the job image data, and second cutting operation data which is data that is different from the first cutting operation data and that can be processed when a second cutting machine executes a cutting operation on the cutting target;
a second step of accepting job identification information indicating the cutting target and cutting machine identification information indicating a type of a cutting machine that executes cutting; and
a third step of transmitting the first cutting operation data to the first cutting machine when the cutting machine identification information indicating the first cutting machine is accepted in the second step, and transmitting the second cutting operation data to the second cutting machine when the cutting machine identification information indicating the second cutting machine is accepted in the second step.

2. The cutting control method according to claim 1, wherein
the job identification information is printed on a medium,
the job identification information is read from the medium by a reading device corresponding to each of the cutting machines, and
the cutting machine identification information is information indicating the cutting machine corresponding to the reading device reading the job identification information of the medium.

3. The cutting control method according to claim 1, wherein
in the first step, the first cutting operation data and the second cutting operation data are generated, based on cut image data generated based on an object to which a predetermined name included in the job image data is assigned.

4. The cutting control method according to claim 1, wherein
in the first step, the job identification information common to both the first cutting operation data and the second cutting operation data is assigned.

5. The cutting control method according to claim 1, wherein
the job identification information is printed as a barcode on the medium.

6. The cutting control method according to claim 2, wherein
each of the first cutting machine and the second cutting machine includes an optical sensor as the reading device.

7. The cutting control method according to claim 1, wherein
before the first step, cutting machine registration information, which is information indicating a type of a registered cutting machine including the first cutting machine and the second cutting machine, is acquired, and
cutting operation data generated in the first step differs according to the cutting machine registration information.

8. A cutting control system comprising:
an information processing device;
a first cutting machine; and
a second cutting machine, wherein
the information processing device comprises:
a generation unit configured to generate, based on job image data, first cutting operation data which is data that can be processed when the first cutting machine executes a cutting operation, and second cutting operation data which is data that is different from the first cutting operation data and that can be processed when the second cutting machine executes a cutting operation;
an acceptance unit configured to accept job identification information indicating a cutting target and cutting machine identification information indicating a type of a cutting machine that executes cutting; and
a transmission unit configured to transmit the first cutting operation data to the first cutting machine when the cutting machine identification information indicating the first cutting machine is accepted, and transmit the second cutting operation data to the second cutting machine when the cutting machine identification information indicating the second cutting machine is accepted.

9. An information processing device that communicates with a first cutting machine and a second cutting machine, the information processing device comprising:
a generation unit configured to generate, based on job image data, first cutting operation data which is data that can be processed when the first cutting machine executes a cutting operation, and second cutting operation data which is data that is different from the first cutting operation data and that can be processed when the second cutting machine executes a cutting operation;
an acceptance unit configured to accept job identification information indicating a cutting target and cutting machine identification information indicating a type of a cutting machine that executes cutting; and
a transmission unit configured to transmit the first cutting operation data to the first cutting machine when the cutting machine identification information indicating the first cutting machine is accepted, and transmit the second cutting operation data to the second cutting machine when the cutting machine identification information indicating the second cutting machine is accepted.
